(19) United States
(12) Patent Application Publication
(10) Pub. No.: US 2025/0279470 A1
(43) Pub. Date: Sep. 4, 2025

(54) CELLULOSIC-PROTEIN IONIC GEL, METHOD OF MANUFACTURE THEREOF AND ARTICLES COMPRISING THE SAME

(71) Applicant: University of Connecticut, Farmington, CT (US)

(72) Inventors: Rajeswari Kasi, South Windsor, CT (US); Francis Masese, Willington, CT (US); Dennis Ndaya, Willimantic, CT (US); Ankarao Kalluri, Acton, MA (US); Challa Vijaya Kumar, Ashford, CT (US)

(21) Appl. No.: 19/068,754

(22) Filed: Mar. 3, 2025

Related U.S. Application Data
(60) Provisional application No. 63/560,261, filed on Mar. 1, 2024.

(51) Int. Cl. H01M 10/0565; H01M 12/06

(52) U.S. Cl. CPC H01M 10/0565; H01M 12/06; H01M 2300/0082

(57) ABSTRACT

Disclosed herein is an electrolyte composition for an energy storage device, the electrolyte composition comprising cellulose nanocrystals; a liquid crystalline unit; an ionic liquid; a metal ion; and a solid protein; wherein the cellulose nanocrystals are conjugated with the liquid crystalline unit. Disclosed herein too is a zinc air battery comprising a positive electrode; a negative electrode; and an electrolyte disposed between the positive electrode and the negative electrode; wherein the electrolyte comprises cellulose nanocrystals; a liquid crystalline unit; an ionic liquid; a metal ion; and a solid protein; wherein the cellulose nanocrystals are conjugated with the liquid crystalline unit.

### CROSS-REFERENCE TO RELATED APPLICATIONS

This disclosure claims priority to U.S. Provisional Application having Ser. No. 63/560,261 filed on Mar. 1, 2024, the entire contents of which are hereby incorporated by reference.

### BACKGROUND OF THE INVENTION

### 1. Field of the Invention

Disclosed herein is a cellulosic-protein ionic gel, a method of manufacture thereof and an article comprising the same.

### 2. Description of the Related Art

Solid-state electrolytes (SSEs) are a useful component in the development of next-generation batteries, particularly solid-state batteries (SSBs), which aim to offer improvements over conventional liquid electrolyte-based batteries. The primary advantage of solid-state electrolytes is their potential to improve the safety, energy density, and performance of batteries.

At sub-zero temperatures, solid-state electrolytes face challenges that hinder their performance. One of the primary issues is the reduction in ionic conductivity, as many solid electrolytes become less effective at low temperatures. They tend to experience a drastic decrease in conductivity as the temperature drops, making them unsuitable for cold-weather applications. Additionally, certain solid-state electrolytes can become brittle or mechanically unstable in freezing conditions, leading to cracking or failure during battery cycling. The formation of dendrites can also be exacerbated at low temperatures, increasing the risk of short circuits and reducing battery lifespan. These issues make solid-state batteries less reliable and efficient in extreme cold, requiring ongoing research to develop materials that maintain high performance under sub-zero conditions.

Therefore, it is essential to develop solid-state electrolytes that exhibit stable electrochemical properties, strong mechanical characteristics, elastomeric qualities, and high ionic conductivity, particularly under sub-zero temperature conditions.

### SUMMARY OF THE INVENTION

Disclosed herein is an electrolyte composition for an energy storage device, the electrolyte composition comprising cellulose nanocrystals; a liquid crystalline unit; an ionic liquid; a metal ion; and a solid protein; wherein the cellulose nanocrystals are conjugated with the liquid crystalline unit.

Disclosed herein is a zinc air battery comprising a positive electrode; a negative electrode; and an electrolyte disposed between the positive electrode and the negative electrode; wherein the electrolyte comprises cellulose nanocrystals; a liquid crystalline unit; an ionic liquid; a metal ion; and a solid protein; wherein the cellulose nanocrystals are conjugated with the liquid crystalline unit.

### BRIEF DESCRIPTION OF THE DRAWINGS

The features and advantages of the invention are apparent from the following description taken in conjunction with the accompanying drawings in which:

FIG. 1 depicts a schematic process for manufacturing a cellulosic-protein ionic gel;

FIG. 2 contains a table that depicts temperature dependent ionic conductivities for different gel types;

FIG. 3 is a graph that depicts the electrochemical behavior of a cellulosic-protein ionic gel;

FIG. 4 is a graph that depicts differential scanning calorimetry (DSC) thermal curves of an ionic gel electrolyte with different concentrations of Zn ions;

FIG. 5 is a graph that depicts the UV-visible spectra of different compositions of cellulosic-protein ionic gels;

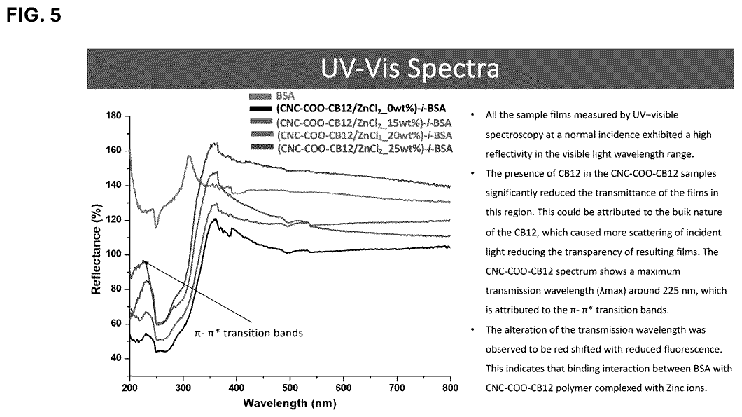

FIG. 6 is a graph that depicts the thermal behavior of different compositions of cellulosic-protein ionic gels;

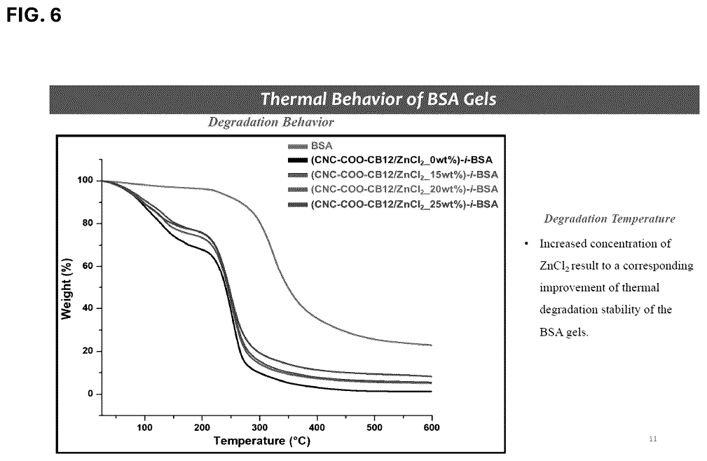

FIG. 7 contains a table that depicts the longitudinal and cross-sectional area ionic conductivity of different compositions of cellulosic-protein ionic gels at room temperature;

FIG. 8 contains a bar diagram that depicts the temperature dependent ionic conductivity of different compositions of cellulosic-protein ionic gels;

FIG. 9 is a table that details the properties of the state-of-the-art liquid and solid-state reversible Zn-air batteries; and

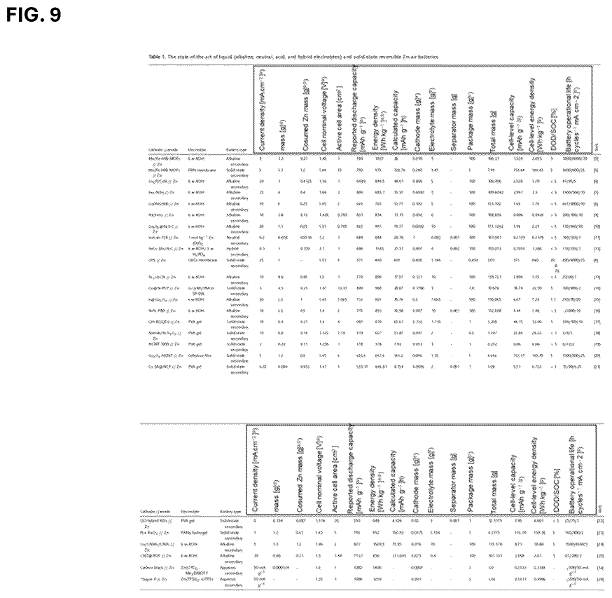

FIG. 10 is a table that details the performance of cellulosic-protein ionic gel in various solid-state batteries.

### DETAILED DESCRIPTION OF THE INVENTION

Disclosed herein is an environmentally friendly cellulosic-protein ionic gel (hereinafter ionic gel) comprising cellulose nano crystals (CNCs), a liquid crystalline unit (LC), an ionic liquid, a metal ion and a solid protein. The ionic gel has superior antifreeze properties (−70° C.) and excellent conductivity properties especially at subzero temperatures. This ionic gel is advantageous because: (1) the use of a non-flammable ionic liquid serves to reduce instances of fire and explosion; (2) the high flash point of the ionic liquid also helps to address issues with reduced battery performance reported in lithium-ion battery cells, and (3) can perform as aqueous zinc-ion batteries (AZIBs). Additionally, the ionic gel does not contain ethylene glycol. The presence of ethylene glycol in gel electrolytes affects the kinetics of charge transfer reactions related to the redox process. This includes issues like reduced metal dissolution, which can negatively impact the overall performance of these gels, particularly at low temperatures. Also disclosed herein is a method of manufacturing an energy storage device comprising an ionic gel. Disclosed herein too is an article comprising an energy storage device. To manufacture an ionic gel, the first step involves dissolving the CNCs conjugated with LC unit in an ionic liquid. A sequential addition of aqueous metal solution, solid protein and carbodiimide reagent to the ionic liquid solution comprising the conjugated CNC-LC mixture facilitates the formation of mechanically robust homogenous ionic gel. These ionic gels are also elastic over a wide range of low temperatures (RT to −60° C.) and showed excellent antifreeze properties and excellent electrochemical stability. They exhibit a high ionic conductivity of at least 11.4 milli-Siemens per centimeter (mScm⁻¹) at room temperature, at least 5.48 mScm⁻¹ at −20° C., and at least 4.25 mScm⁻¹ at −40° C., the highest ionic conductivity reported below −20° C. for non-ethylene glycol systems. In an embodiment, these ionic gels can be tuned or attenuated by exposure to ultraviolet (UV) light, resulting in improved ionic conductivity. In another embodiment, the ionic conductivity can also be improved by altering the orientation of LC unit.

Zinc air batteries (ZABs) that are assembled using these ionic gels as electrolytes have an open circuit voltage of >1.0 volts (V), energy density of >900 watt-hours per kilogram (Whkg⁻¹), power density of >100 milliwatts per square centimeter (mWcm⁻²), comparable to those of the current state-of-the-art ZABs. They are also stable at room temperature for more than 3 months. The exceptional properties of this ionic gel electrolyte/ZABs platform may advance new applications in space, deep-sea exploration, flexible wearable storage devices and electronics, electric vehicles even under subzero conditions.

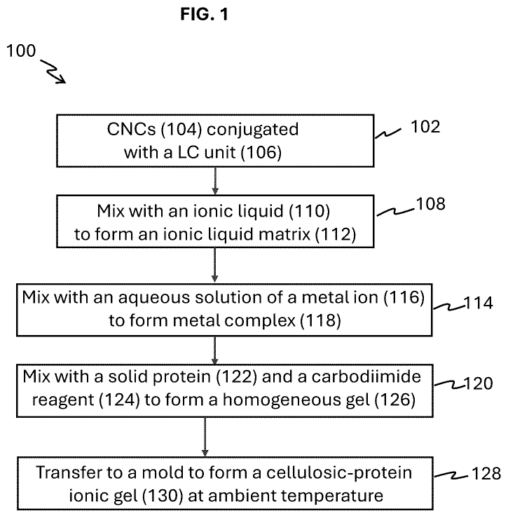

FIG. 1 illustrates the process 100 for manufacturing a cellulosic-protein ionic gel. CNCs 104 conjugated with a LC unit 106 (see 102) is combined with an ionic liquid 110 to form an ionic liquid matrix 112 (see 108). To the resulting ionic liquid matrix 112, an aqueous solution of a metal ion 116 is added resulting in the formation of a metal complex 118 with the ionic liquid matrix 112 (see 114). A solid protein 122 and a carbodiimide reagent 124 are added to the metal complex 118 resulting in a homogeneous gel 126 (see 120). The homogeneous gel 126 is then transferred to a mold to form the desired cellulosic-protein ionic gel 130 at ambient temperature (see 128).

CNCs are derived from cellulose which is abundantly available and possess one-dimensional structural arrangement, high specific surface area, and chemical functionalities. CNCs enable their facile generation of novel structural carbonaceous materials and seamless incorporation with electroactive materials. The large number of hydroxyl groups (anchor points) in their linear polymer backbone provides them with chemical modification capabilities and hydrophilicity.

In an embodiment, the CNCs are conjugated with a LC unit. This conjugated mixture behaves as a structure-directing agent, an internal plasticizer, a hydrogen bonding agent and can also undergo bonding to a solid protein. LC units are structures that exhibit both liquid-like and crystalline properties, forming ordered phases at certain temperatures or under specific conditions. These units are often used in materials such as liquid crystals for displays, sensors, and other advanced materials. Examples of liquid crystalline units include biphenyls, pyrimidine diol derivatives, azobenzene derivatives and cholesterol derivatives. In a preferred embodiment, the LC unit comprises a cyanobiphenyl unit (CB).

In an embodiment, a spacer is used between CNCs and LC unit to ensure proper alignment, flexibility, and stability of the system. The choice of the spacer depends on the desired properties of the final material, such as the degree of mesophase (an intermediate phase between a liquid and a solid) formation, mechanical strength, and solubility. Examples of spacers that can be used between CNCs and LC units include aliphatic chains, ether groups, aromatic groups, carbonate or ester linkages, polymeric spacers, siloxane groups, carboxylate groups and the like. In a preferred embodiment, a methylene spacer is used between CNCs and a LC unit.

In an embodiment, a LC unit may comprise a spacer with 4 to 20 carbon atoms, preferably 4 to 16, and more preferably 6 to 14 carbon atoms. In a preferred embodiment, cyanobiphenyl LC unit with a spacer containing 12 carbon atoms (CB12) is used.

The CNCs conjugated with LC is present in an amount of 1 to 30 wt %, preferably 1 to 20 wt %, and more preferably 5 to 10 wt %, based on the total weight of the components used to make the ionic gel.

As noted in FIG. 1, CNCs conjugated with a LC unit are combined with an ionic liquid. Ionic liquids are used in ionic gel electrolytes due to their useful properties, including low volatility, high thermal stability, and excellent ionic conductivity. These properties make them suitable for use in energy storage systems, sensors, and other electrochemical applications. In ionic gel electrolytes, ionic liquids serve as the primary medium for ion transport, replacing traditional solvents that may evaporate or degrade under extreme conditions. Furthermore, ionic liquids can be easily integrated into gel matrices, providing additional mechanical support and preventing leakage, which improves the safety and durability of the final electrolyte materials. The combination of ionic liquids with other components, such as cellulose-based materials or liquid crystalline units, can further tailor the properties of the ionic gel, allowing for the design of advanced materials with specific performance characteristics for a range of applications. The selected ionic liquid should be able to solubilize or uniformly disperse CNCs with LC unit, protein and metal salt. The flash point of ionic liquids selected herein should ideally be high (>100° C.) to ensure safety, as ionic liquids are often chosen for their non-volatile nature. Examples of suitable ionic liquids include imidazolium-based ionic liquids, pyridinium-based ionic liquids, ammonium-based ionic liquids, phosphonium-based ionic liquids, choline-based ionic liquids, aryl-based ionic liquids, bistriflimide-based ionic liquids and urea based ionic liquids. In a preferred embodiment, the ionic liquid comprises 1-butyl-3-methylimidazolium acetate.

The ionic liquid is present in an amount of 50 to 99.5 wt %, preferably 50 to 95 wt %, and more preferably 60 to 90 wt %, based on the total weight of the components used to make the ionic gel.

As noted in the FIG. 1, an aqueous solution of the metal ion is added to the ionic liquid solution comprising conjugated CNCs and LC. In ionic gels, metal ions are useful for enhancing ionic conductivity, supporting electrochemical reactions, or stabilizing the gel structure. These metal ions can come from various sources, depending on the type of ionic gel and its intended application, such as in batteries, supercapacitors, or sensors. The choice of metal ion used in ionic gels depends on its ability to form stable hydrates with octahedral and tetrahedral geometric structures which in turn creates multiple hydroxyl coordination sites for hydrogen bonding. Some common metal ions used in the preparation of ionic gels include Na⁺, K⁺, Ca²⁺, Mg²⁺, Zn²⁺, Al³⁺, Fe²⁺/Fe³⁺, Cu²⁺, Ni²⁺, Co²⁺/Co³⁺, Sn²⁺/Sn⁴⁺, Bi³⁺, Pb²⁺/Pb⁴⁺, Ag⁺, Mn²⁺/Mn³⁺ and Lit. In a preferred embodiment, the metal ion comprises Zn²⁺. The metal ions are sourced from aqueous solutions of metal salts, which dissolve in water to release positively charged metal cations. Some common metal salts that are used as an aqueous solution include sodium chloride, sodium sulfate, potassium chloride, potassium sulfate, calcium chloride, calcium nitrate, magnesium sulfate, magnesium chloride, magnesium acetate, zinc sulfate, zinc acetate, aluminum chloride, aluminum sulfate, aluminum nitrate, iron sulfate, iron chloride, copper sulfate, silver nitrate and the like. In a preferred embodiment, an aqueous solution of zinc chloride (ZnCl₂) is used as a source of metal ion.

The metal salt is used in an amount of 1 to 50 wt %, preferably 10 to 40 wt %, and more preferably 10 to 30 wt %, based on the total weight of the components used to make the ionic gel.

In an embodiment, an ionic gel comprises a solid protein. This solid protein can act as structural component in ionic gels. These solid proteins can help form a stable network that supports the gel-like structure of the electrolyte. This gel structure helps retain the ionic liquid and metal ions within the ionic liquid matrix, and to maintain consistent electrochemical behavior over time. The selected protein should have sufficient carboxylic acid and amine groups for crosslinking with the cellulose nanocrystal and to bond with metal salts. Suitable solid proteins that can be used for this application include collagen, gelatin, silk fibroin, and casein, keratin, ovalbumin, albumin fibrinogen, wheat gluten, papain and zein proteins. In an embodiment, the solid protein comprises solid bovine serum albumin (BSA).

The solid protein is used in an amount of 1 to 30 wt %, preferably 1 to 20 wt %, and more preferably 5 to 15 wt %, based on the total weight of the components used to make the ionic gel.

In an embodiment, a carbodiimide reagent is used to form covalent crosslinking between CNCs, metal ions and proteins. Carbodiimide reagents which are often employed in coupling reactions to link acids (like carboxylic acids) with amines or alcohols are especially valuable in biochemistry. They are preferred due to their ability to work under without the need for harsh reagents like acids (pH 2 to 3) or bases (pH 12 to 14). Examples of suitable carbodiimide reagents include dicyclohexylcarbodiimide (DCC), N,N′-carbonyldiimidazole (CDI), N,N′-diisopropylcarbodiimide (DIPC) and pentafluorophenyl carbodiimide (PFPC) or a combination thereof. In a preferred embodiment, the carbodiimide reagent comprises N-(3-dimethylaminopropyl)-N′-ethylcarbodiimide (EDC·HCl).

Carbodiimide reagent is used in an amount of 0.1 to 10 wt %, preferably 0.1 to 5 wt %, and more preferably 1 to 5 wt %, based on the total weight of the components used to make the ionic gel.

As shown in FIG. 1, CNCs conjugated with a liquid crystal unit is combined with an ionic liquid in a round bottomed flask. The resulting solution is stirred for 30 minutes at 80° C. and 1 mL of an aqueous solution of metal salt is added. The resulting mixture is then stirred for one hour, and then cooled to 60° C. Solid protein is then added and the resulting mixture is stirred for 30 minutes before a powder of carbodiimide reagent is added. This mixture is then transferred to a mold to gel at ambient temperature. The prepared ionic gel can be applied as an electrolyte between the zinc anode and the air cathode during the preparation of Zinc-air batteries. This can be done by placing a layer of gel onto the anode or between both electrodes, ensuring full coverage for proper ion conduction. The gel may be enclosed within the battery by using a membrane or housing. This helps to contain the gel and prevent it from leaking or drying out. The battery is then sealed to maintain the integrity of the gel and the internal environment of the battery.

The thermal behaviors, microstructural interactions, mechanical integrity, and low-temperature properties of these ionic gels were characterized by thermogravimetric analysis (TGA), differential scanning calorimeter (DSC), Fourier transform infrared (FTIR), Ultraviolet-visible (UV-Vis) spectroscopy, and rheological studies (ESI).

### EXAMPLES

### Example 1

This example is conducted to demonstrate the manufacturing method for an ionic gel. As shown in FIG. 1, cellulosic nanocrystals conjugated with cyanobiphenyl liquid crystal unit CNC—COO—CB12 (0.375 g, 7.5 wt %) is combined with 4 mL of 1-butyl-3-methylimidazolium acetate in a round bottomed flask. The resulting solution is stirred for 30 minutes at 80° C. and 1 mL of aqueous ZnCl₂ (0.75 g, 15 wt %) solution is added. The resulting mixture is then stirred for one hour, and then cooled to 60° C. Solid bovine serum albumin BSA (0.75 g, 15 wt %) is added and the resulting mixture is stirred for 30 minutes before a powder of N-ethyl-N′-(3-dimethylaminopropyl) carbodiimide hydrochloride EDC·HCl (0.1 g, 2 wt %) is added. This mixture is then transferred to a mold to gel at ambient temperature. Ionic gels with different concentrations of ZnCl₂ can be manufactured using a similar protocol.

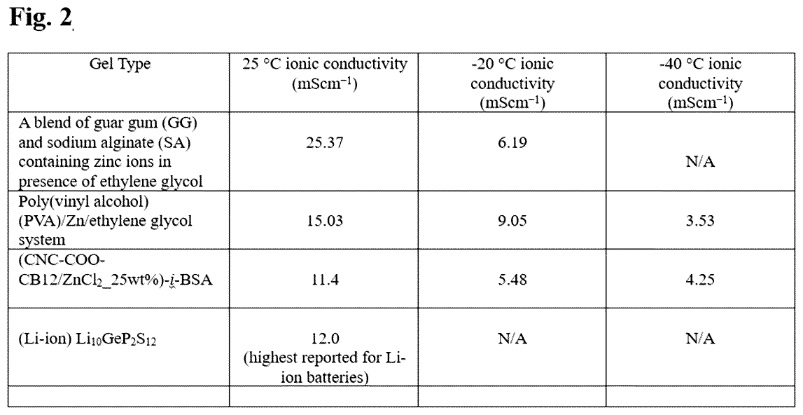

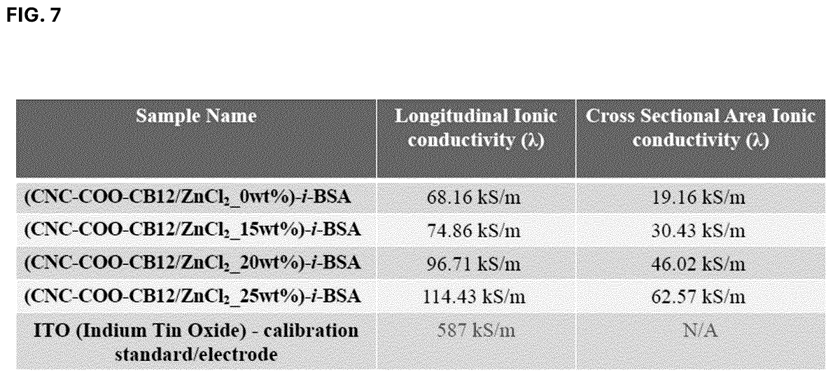

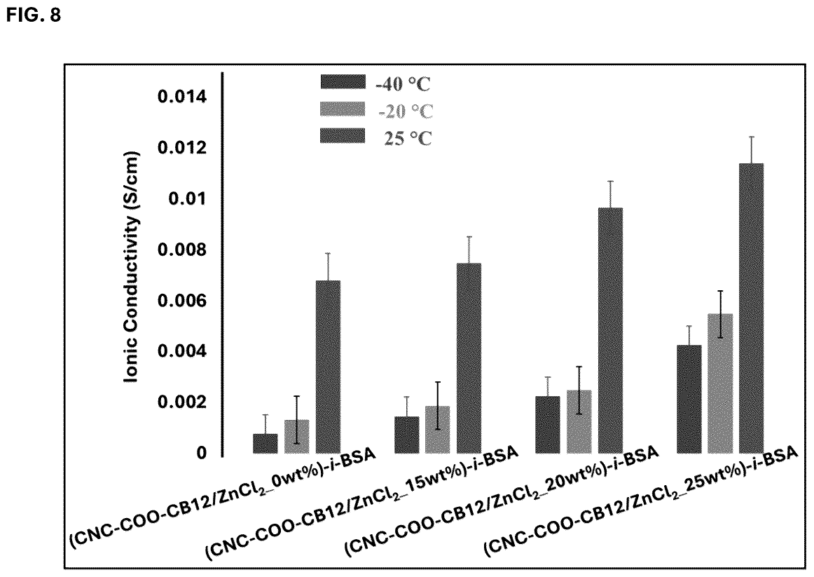

This example is conducted to demonstrate the ionic conductivity of ionic gels at different temperatures. FIG. 2 provides the temperature dependent ionic conductivity of different gel types. As shown in FIG. 2, the ionic gel system with 25 wt % of ZnCl₂ exhibited a high ionic conductivity of 11.4 mScm⁻¹ at room temperature and 5.48 mScm⁻¹ at −20° C. and 4.25 mScm⁻¹ at −40° C. These values are amongst the highest reported for solid state non-ethylene glycol systems. FIG. 7 provides the longitudinal and cross-sectional area ionic conductivity of different compositions of ionic gels at room temperature. FIG. 8 provides the temperature dependent ionic conductivity of different compositions of ionic gels. As shown in FIG. 8, the measured ionic conductivity for the composites increased with Zn²⁺ concentration. The improvement in ionic conductivity could be attributed to the presence of sufficient ions for rapid migration, the presence of CNC—COO—CB12 as a good dispersion medium of zinc ions, and some level of order due to the presence of LC units of CB12 and CNCs.

The ionic gel can be used as an electrolyte in solid-state zinc air batteries (ZABs). Once the ionic gel electrolyte is prepared, it is applied directly to the surface of the zinc anode in a thin, even layer. This is often done by laminating or coating the gel onto the anode. The gel serves as the medium that allows ions to flow between the anode and cathode. After applying the ionic gel to the anode, the cathode and anode are carefully aligned and assembled with a separator in between. The separator is typically a thin, porous material that prevents the anode and cathode from short-circuiting while still allowing ion flow through the ionic gel electrolyte. The battery assembly is then sealed in a casing, often with a vent to allow the cathode to absorb oxygen from the air.

To prepare cathodes, carbon cloth is first cut into rectangular flags with a thin extension strip that can be used both as a coating surface and to connect the battery to an external circuit. The cathodes are prepared by coating the carbon cloth with various conductive materials, such as carbon nanotube-phthalic acid (CNT-PA), carbon nanotube-bovine serum albumin/iron (II) phthalocyanine (CNT-BSA/Fe—PC), and bio-graphene, with uncoated carbon cloth used as a control.

The anode can be prepared by cutting a flexible zinc sheet into a flag shape, then sanding its surface to remove insulating particles. The zinc surface is then laminated with an ionic gel.

To assemble the Zn-air battery, the electrodes are first cut into a flag shape. Initially, 2.2 cm×4.2 centimeter (cm) strips of carbon cloth with 2.2×0.5 cm flag extensions and 2×2 cm of Zn metal sheet with 2.2×0.5 cm flag extension strips are prepared. 3×4 cm of ordinary paper was cut to separate the Zn metal (anode) from the carbon cloth (cathode). The ionic gel is laminated onto the zinc metal and allowed to gel at room temperature, and a U-shaped ordinary paper was fold wrapped against zinc metal to cover the entire area. A subsequent lamination is performed on the ordinary paper and U-shaped carbon cloth before the base of the carbon cloth was wrapped against the ordinary paper (separator). The entire setup was finally wrapped with a dialysis membrane bag with a gentle press to hold the battery components together. The presence of BSA in the gel also served to keep all components together. After the setup, a gentle press was performed to uniformly distribute the gel and ensure maximum contact with the battery components. Electrical contacts are made directly with the electrode flag strip with copper clips. The batteries can be stored at room temperature for an extended time.

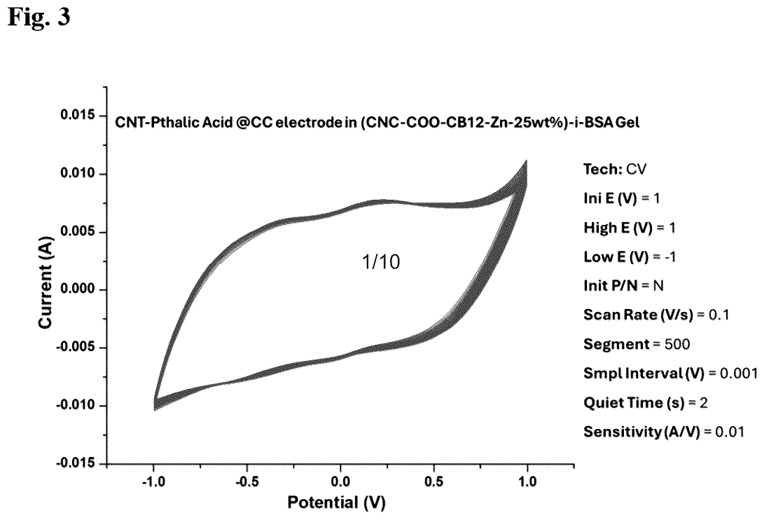

The electrochemical behavior of ionic gel through CNT-phthalic acid @carbon cloth electrode by cyclic voltammetry is shown in FIG. 3. The 1000 cycles performed showed that the gel is electrochemically stable without apparent degradation.

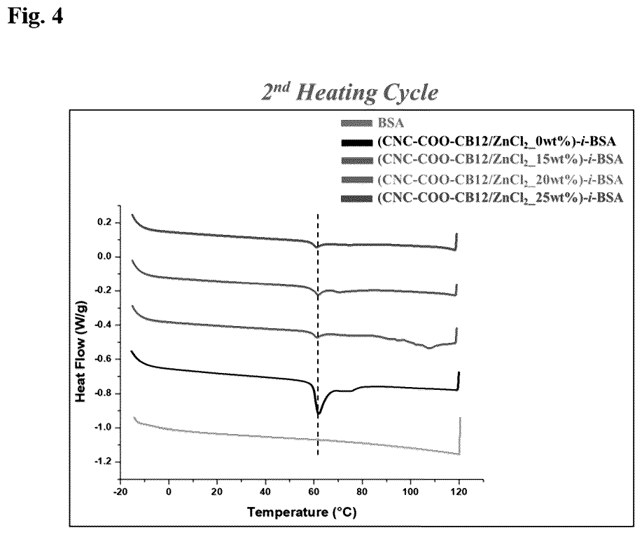

Differential scanning calorimetry (DSC) thermal curves of ionic gels with different concentrations of Zn ions can be seen in FIG. 4. Based on the DSC analysis, the gels can be optimally operated to a maximum temperature of 60 degrees before observing microstructural changes of the gel.

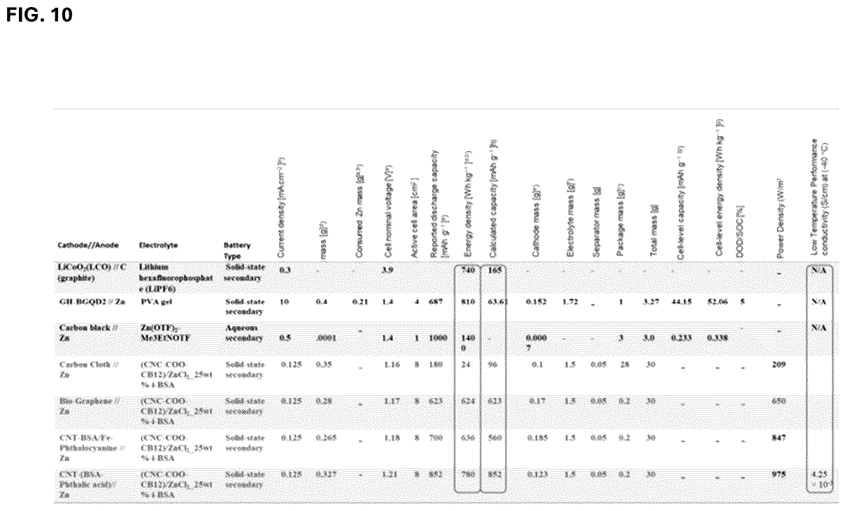

The performance of ionic gel in different solid-state batteries is provided in FIG. 10.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Various other components may be included and called upon for providing for aspects of the teachings herein. For example, additional materials, combinations of materials and/or omission of materials may be used to provide for added embodiments that are within the scope of the teachings herein. Adequacy of any particular element for practice of the teachings herein is to be judged from the perspective of a designer, manufacturer, seller, user, system operator or other similarly interested party, and such limitations are to be perceived according to the standards of the interested party.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein. No functional language used in claims appended herein is to be construed as invoking 35 U.S.C. § 112(f) interpretations as “means-plus-function” language unless specifically expressed as such by use of the words “means for” or “steps for” within the respective claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. The term “exemplary” is not intended to be construed as a superlative example but merely one of many possible examples.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention is not limited to the particular embodiments disclosed as the best mode contemplated for carrying out this invention, but that the invention will include all embodiments falling within the scope of the appended claims.

What is claimed is:

1. An electrolyte composition for an energy storage device, the electrolyte composition comprising:
cellulose nanocrystals;
a liquid crystalline unit;
an ionic liquid;
a metal ion; and
a solid protein;
wherein the cellulose nanocrystals are conjugated with a liquid crystalline unit.

2. The composition of claim 1, wherein the electrolyte composition exhibits an ionic conductivity of at least 11.4 mScm⁻¹ at room temperature, at least 5.48 mScm⁻¹ at −20° C., and at least 4.25 mScm⁻¹ at −40° C.

3. The composition of claim 1, wherein the liquid crystalline unit is selected from a group consisting of biphenyl, pyrimidine diol, azobenzene, cholesterol and cyanobiphenyl derivatives.

4. The composition of claim 3, wherein the liquid crystalline unit has a spacer selected from a group consisting of aliphatic chains, ether groups, aromatic groups, carbonate or ester linkages, polymeric spacers, siloxane groups and carboxylate groups.

5. The composition of claim 3, wherein the liquid crystalline unit has a spacer consisting of 4-20 carbon atoms.

6. The composition of claim 3, wherein the liquid crystalline unit is a cyanobiphenyl liquid crystalline unit.

7. The composition of claim 6, wherein the cyanobiphenyl liquid crystalline unit has a methylene spacer with 12 carbon atoms.

8. The composition of claim 1, wherein an ionic liquid is selected from a group of imidazolium-based ionic liquids, pyridinium-based ionic liquids, ammonium-based ionic liquids, phosphonium-based ionic liquids, choline-based ionic liquids, aryl-based ionic liquids, bistriflimide-based ionic liquids and urea-based ionic liquids.

9. The composition of claim 8, wherein an ionic liquid is 1-butyl-3-methylimidazolium acetate.

10. The composition of claim 1, wherein the metal ion is selected from a group of Na⁺, K⁺, Ca²⁺, Mg²⁺, Zn²⁺, Al³⁺, Fe²⁺/Fe³⁺, Cu²⁺, Ni²⁺, Co²⁺/Co³⁺, Sn²⁺/Sn⁴⁺, Bi³⁺, Pb²⁺/Pb⁴⁺, Ag⁺, Mn²⁺/Mn³⁺ and Li⁺.

11. The composition of claim 10, wherein the metal ion is Zn²⁺.

12. The composition of claim 1, wherein the solid protein is selected from a group of collagen, gelatin, silk fibroin, and casein, keratin, ovalbumin, albumin fibrinogen, wheat gluten, papain, zein, solid bovine serum albumin proteins.

13. The composition of claim 1, wherein the solid protein is a solid bovine serum albumin protein.

14. A zinc air battery comprising:
a positive electrode;
a negative electrode; and
the electrolyte of claim 1 between the positive electrode and the negative electrode.
